(19) United States
(12) Patent Application Publication
(10) Pub. No.: US 2015/0375458 A1
(43) Pub. Date: Dec. 31, 2015

(54) FORMING DEVICE AND A THREE-DIMENSIONAL PRINTING MACHINE HAVING THE SAME

(71) Applicants: XYZ PRINTING, INC., New Taipei City (TW); KINPO ELECTRONICS, INC., New Taipei City (TW); CAL-COMP ELECTRONICS & COMMUNICATIONS COMPANY LIMITED, New Taipei City (TW)

(72) Inventors: Peng-Yang Chen, New Taipei City (TW); Wen-Ten Lin, New Taipei City (TW)

(21) Appl. No.: 14/639,046

(22) Filed: Mar. 4, 2015

(30) Foreign Application Priority Data
Jun. 26, 2014 (TW) 103122089

(51) Int. Cl. B29C 67/00

(52) U.S. Cl. CPC B29C 67/0092; B29C 67/0055; B33Y 30/00

(57) ABSTRACT

A forming device is for use in a three-dimensional printing machine, and includes a holding mechanism and a flexible forming platform. The holding mechanism includes an abutting base having an abutting surface, and a pair of holding units connected to the abutting base. The flexible forming platform includes a forming member having a forming surface and an opposite positioning surface, and two engaging members connected to the forming member. Each engaging member is engageable with a respective holding unit to place the positioning surface in tight abutment with the abutting surface. The flexible forming platform is bendable such that the forming surface is able to flex away and easily separate from a light-curable liquid.

### CROSS-REFERENCE TO RELATED APPLICATION

This application claims priority of Taiwanese Application No. 103122089, filed on Jun. 26, 2014.

### FIELD OF THE INVENTION

The invention relates to a forming device, more particularly to a forming device for a three-dimensional printing machine.

### BACKGROUND OF THE INVENTION

Stereolithography (SL) is a kind of three-dimensional printing technique. U.S. Patent Application Publication No. 20130337100 A1 discloses a stereolithography machine for producing a three-dimensional product.

A household SL three-dimensional printing machine generally includes a container for containing a light-curable liquid therein, and a rigid forming platform. During operation of the SL three-dimensional printing machine, the forming platform enters the container, and the light-curable liquid receives incident beams with a specific wavelength such that part of the light-curable liquid is solidified to form a product layer on the forming platform. Then the forming platform is moved up, followed by solidifying a portion of the remaining light-curable liquid into another product layer. With repetition of the abovementioned steps, a product with a desired shape is formed on the forming platform. The forming platform needs to be removed from the printing machine for retrieval of the product. However, the rigidity of the forming platform makes it difficult to retrieve the formed product attached thereon. A tool, such as a putty knife or a shovel, is often required to separate the formed product from the forming platform. The use of tool may damage the formed product or the forming platform.

### SUMMARY OF THE INVENTION

According to one aspect of the present invention, a forming device for use in a three-dimensional printing machine is provided. The forming device includes a holding mechanism and a flexible forming platform. The holding mechanism includes an abutting base that has an abutting surface, and a pair of holding units that are connected to the abutting base and that are respectively disposed at opposite sides of the abutting surface. The flexible forming platform includes a forming member and a pair of engaging members. The forming member has a forming surface for permitting a light-curable liquid to be solidified and formed thereon, and a positioning surface opposite to the forming surface. The engaging members are connected to the forming member and are respectively disposed at two opposite sides of the positioning surface. Each of the engaging members is engageable with a respective one of the holding units of the holding mechanism to place the positioning surface of the forming member in tight abutment with the abutting surface of the abutting base. The flexible forming platform is bendable such that the forming surface is able to flex away and separate easily from a surface of a product that is formed from the light-curable liquid.

According to another aspect of the present invention, a three-dimensional printing machine is provided. The three-dimensional printing machine includes a container, a laser for producing laser beams, a scanner and a forming device. The container defines a retaining space for retaining a light-curable liquid therein. The retaining space has an upper opening for replenishing the container with the light-curable liquid. The scanner reflects the laser beams produced by the laser to at least a portion of the light-curable liquid. The forming device includes a holding mechanism and a flexible forming platform. The holding mechanism includes an abutting base that has an abutting surface, and a pair of holding units that are connected to the abutting base and that are respectively disposed at opposite sides of the abutting surface. The holding mechanism is vertically movable relative to the container such that the holding mechanism is operable to pass the upper opening and to enter the retaining space. The flexible forming platform includes a forming member and a pair of engaging members. The forming member has a forming surface for permitting said at least a portion of the light-curable liquid to be solidified and formed thereon, and a positioning surface opposite to the forming surface. The engaging members are connected to the forming member and are respectively disposed at two opposite sides of the positioning surface. Each of the engaging members is engageable with a respective one of the holding units of the holding mechanism to place the positioning surface of the forming member in tight abutment with the abutting surface of the abutting base. The flexible forming platform is bendable such that the forming surface is able to flex away and separate easily from a surface of a product that is formed from said at least a portion of the light-curable liquid.

### BRIEF DESCRIPTION OF THE DRAWINGS

Other features and advantages of the present invention will become apparent in the following detailed description of the embodiments with reference to the accompanying drawings, of which:

FIG. 1 is a schematic side view of a first embodiment of a three-dimensional printing machine according to the present invention, illustrating a cover member in a closing state;

FIG. 2 is a view similar to FIG. 1, but illustrating the cover member in an opening state and a product formed on a flexible forming platform;

FIG. 3 is a front view of the first embodiment with a housing being omitted for the sake of clarity;

FIG. 4 is a fragmentary sectional of the first embodiment, illustrating a light-curable liquid that is contained in a container and that is being solidified on the flexible forming platform;

FIG. 5 is an exploded front view of a holding mechanism and the flexible forming platform of the first embodiment;

FIG. 6 is a fragmentary front view of the first embodiment, illustrating the flexible forming platform coupled with the holding mechanism;

FIG. 7 is a view similar to FIG. 6, but illustrating the flexible forming platform being separated from the holding mechanism;

FIG. 8 is a front view of the flexible forming platform with the product being formed thereon;

FIG. 9 is a view similar to FIG. 8, but illustrating the flexible forming platform being bent and partially separated from the product;

FIG. 10 is a fragmentary front view of a second embodiment of the three-dimensional printing machine according to the present invention, illustrating the flexible forming platform coupled with the holding mechanism and the product formed on the flexible forming platform; and

FIG. 11 is a fragmentary side view of the second embodiment in a state the same as FIG. 10.

### DETAILED DESCRIPTION OF THE EMBODIMENTS

Before the present invention is described in greater detail, it should be noted herein that like elements are denoted by the same reference numerals throughout the disclosure.

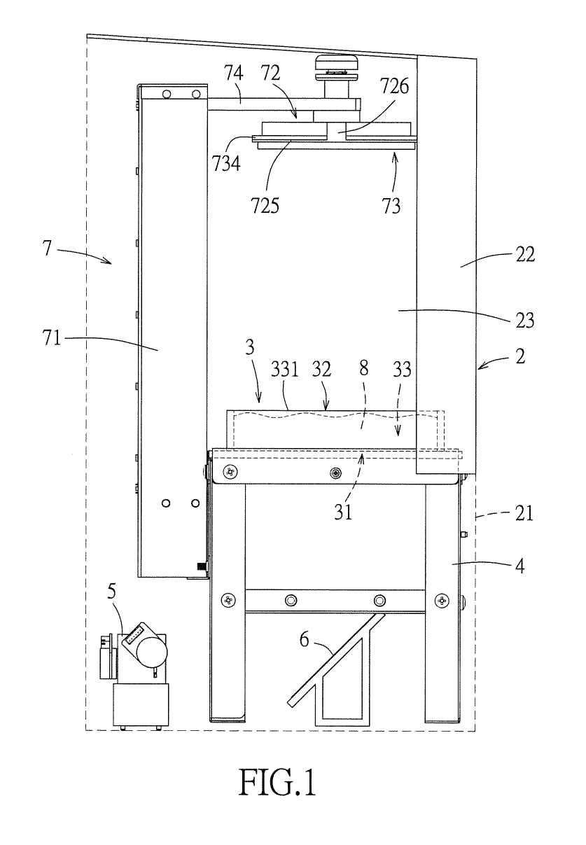

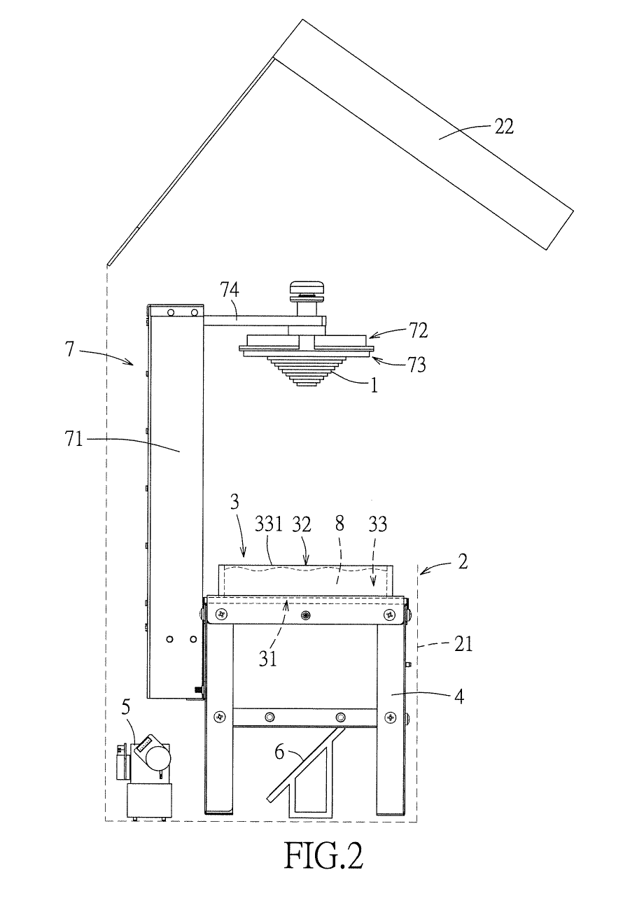

FIGS. 1 and 2 illustrate a first embodiment of a three-dimensional printing machine according to the present invention that includes a housing 2, a liquid container 3, a base 4, a laser 5, a scanner 6 and a forming device 7.

The housing 2 includes a housing body 21, and a covering member 22 connected movably to the housing body 21. The housing body 21 defines a containing space 23 for containing the liquid container 3, the base 4, the laser 5, the scanner 6 and the forming device 7 therein. The covering member 22 is movable between a closing state (see FIG. 1) to cover the containing space 23, and an opening state (see FIG. 2) to uncover the containing space 23.

The liquid container 3 is mounted on the base 4 for containing a light-curable liquid 8 therein. The liquid container 3 includes a light-transmissive base wall 31 and a surrounding wall 32 vertically extending from the base wall 31. The base wall 31 and the surrounding wall 32 cooperatively define a retaining space 33 for retaining the light-curable liquid 8 therein. The retaining space 33 has an upper opening 331 for replenishing the liquid container 3 with the light-curable liquid 8.

The laser 5 is located at a position lower than the liquid container 3 and produces laser beams with a specific wavelength toward the scanner 6. The scanner 6 is located underneath the liquid container 3 and reflects the laser beams from the laser 5 toward the base wall 31 of the liquid container 3 in order to cure at least a portion of the light-curable liquid 8 retained in the liquid container 3. Technique of producing laser beams is well-known in the art and therefore is not further elaborated for the sake of brevity.

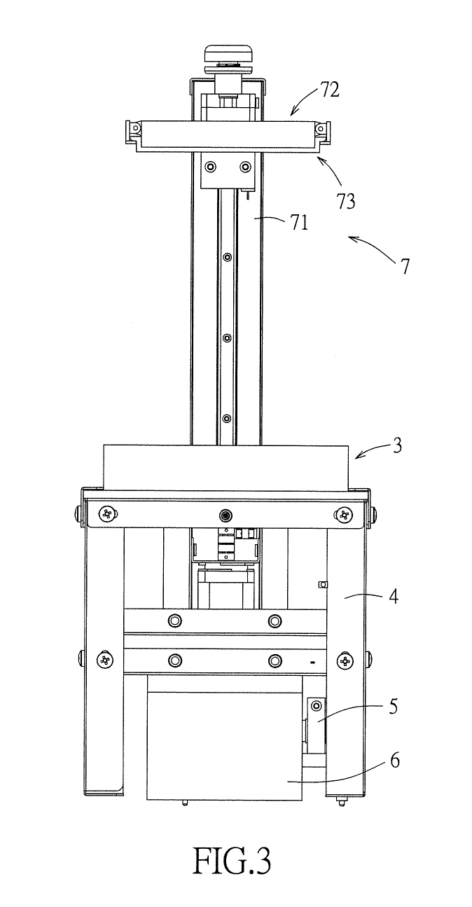

Referring further to FIGS. 3 to 7, the forming device 7 includes a sliding rail 71, a holding mechanism 72, a flexible forming platform 73 and a connecting arm 74. The sliding rail 71 is connected to and extends vertically from a lateral end of the base 4. The connecting arm 74 has an end received in and slidable along the sliding rail 71, and has an opposite end connected to the holding mechanism 72.

The holding mechanism 72 includes an abutting base 721 that has an abutting surface 7210, and a pair of holding units 722 that are connected to the abutting base 721 and that are respectively disposed at opposite sides of the abutting surface 7210. Each of the holding units 722 includes a pivot member 723 that is disposed at the respective one of the opposite sides of the abutting surface 7210, and a hooking member 724 that is pivotally connected to the pivot member 723. The hooking member 724 of each of the holding units 722 includes a hooking part 725 and a pivoting part 726 that extends transversely from the hooking part 725 and that is pivotally connected to the pivot member 723.

The flexible forming platform 73 includes a forming member 731 and a pair of engaging members 732. The forming member 731 has a forming surface 7320 for permitting the light-curable liquid 8 to be solidified and formed thereon, and a positioning surface 7310 opposite to the forming surface 7320. The engaging members 732 are connected to the forming member 731 and are respectively disposed at two opposite sides of the positioning surface 7310. The engaging members 732 cooperate with the forming member 731 to define a recess 733 contiguous to the positioning surface 7310. In other words, the recess 733 is on the side of the positioning surface 7310 as opposed to being on the side of the forming surface 7320. Each of the engaging members 732 includes an engaging end 734 that is substantially parallel to the positioning surface 7310 of the forming member 731, and a connecting wall 735 that extends transversely between and interconnects the engaging end 734 and the forming member 731. The engaging end 734 protrudes from the connecting wall 735 in a direction away from the forming member 731.

The engaging end 734 of each of the engaging members 732 of the flexible forming platform 73 is removably engaged with the hooking part 725 of the hooking member 724 of the respective one of the holding units 722 to couple the holding mechanism 72 to the flexible forming platform 73, such that the abutting base 721 is received in the recess 733 with the positioning surface 7310 of the forming member 731 tightly abutting against the abutting surface 7210 of the abutting base 721.

The flexible forming platform 73 may be made of rubber or steel.

Operation of the three-dimensional printing machine will be described below.

Referring particularly to FIGS. 1, 3 and 6, the light-curable liquid 8 is added in advance into the retaining space 33. The covering member 22 is moved to the covering state. At this time, the connecting arm 74 is at a top end of the sliding rail 71 such that the coupled pair of the holding mechanism 72 and the flexible forming platform 73 is above the liquid container 3. Each of the engaging members 732 of the flexible forming platform 73 is engaged with the respective one of the holding units 722 of the holding mechanism 72. The hooking part 725 of each of the holding units 722 holds the engaging end 734 of the respective one of the engaging members 732 such that the abutting base 721 is received in the recess 733, and that the positioning surface 7310 of the forming member 731 tightly abuts against the abutting surface 7210 of the abutting base 721.

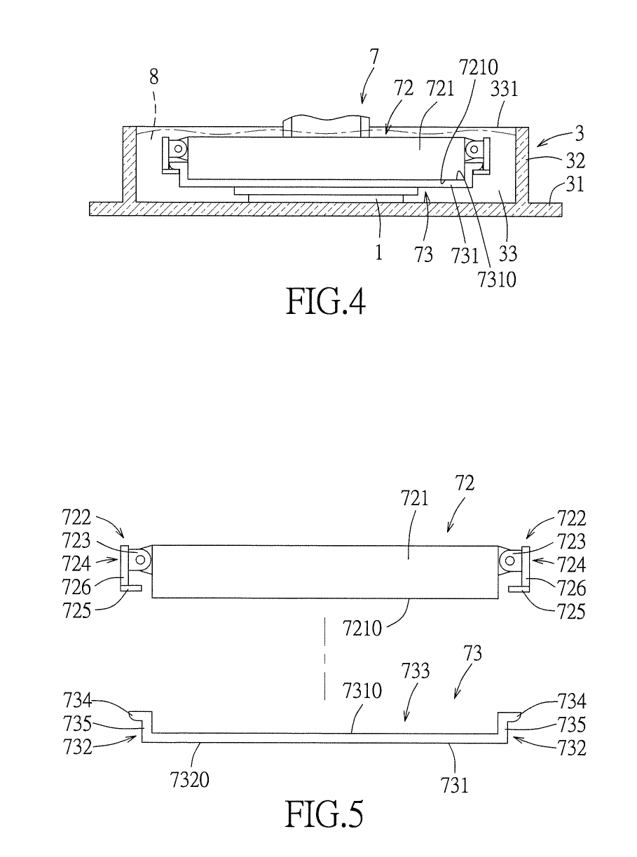

Then, the connecting arm 74 descends along the sliding rail 71 such that the coupled pair of the holding mechanism 72 and the flexible forming platform 73 passes through the upper opening 331, enters the retaining space 33 and stops at a position proximate to the base wall 31 (see FIG. 4). The laser 5 produces the laser beams that are reflected by the scanner 6 to pass through the light-transmissive base wall 31 and enter the retaining space 33. A portion of the light-curable liquid 8 receives the incident laser beams with the specific wavelength such that said portion of the light-curable liquid 8 is solidified to form a product layer on the forming surface 7320 of the flexible forming platform 73. Then, the coupled pair of the holding mechanism 72 and the flexible forming platform 73 moves up relative to the base wall 31. The laser 5 and the scanner 6 cooperate to irradiate laser beams to solidify a portion of the remainder of the light-curable liquid 8 to form another product layer. With repetition of abovementioned curing steps, a product 1 with a desired shape is formed on the forming surface 7320 of the flexible forming platform 73. With the tight abutment between the positioning surface 7310 of the forming member 731 and the abutting surface 7210 of the abutting base 721, the forming member 731 does not tilt during formation of the product 1.

Then, the connecting arm 74 moves back to the top end of the sliding rail 71, bringing the coupled pair of the holding mechanism 72 and the flexible forming platform 73 away from the liquid container 3. The covering member 22 is moved to the opening state to uncover the containing space 33, so that the flexible forming platform 73 and the product 1 formed thereon can be retrieved by a user.

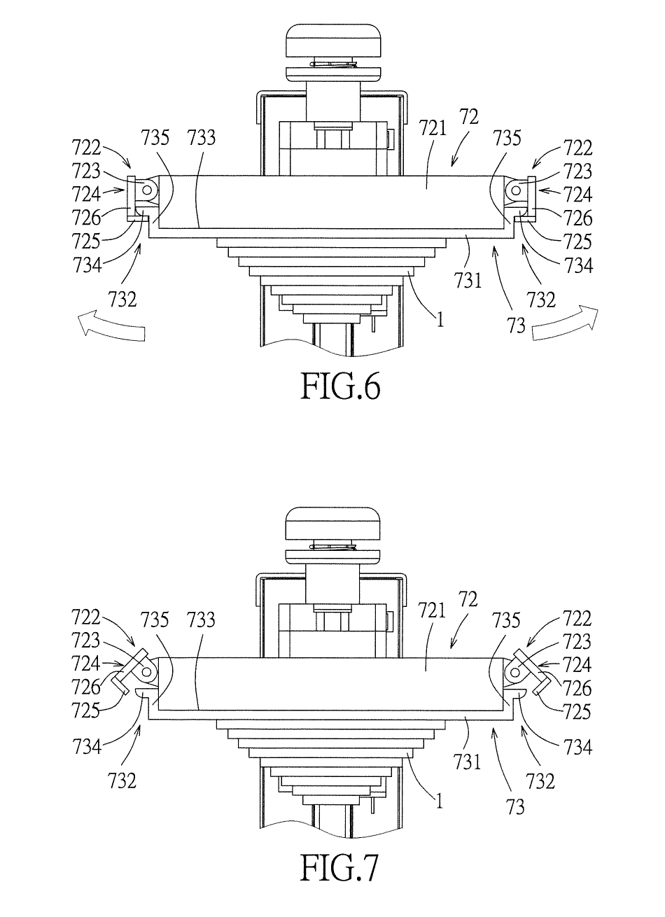

To remove the flexible forming platform 73 and the product 1 from the holding mechanism 72, referring particularly to FIGS. 6 and 7, the hooking member 724 of each of the holding units 722 is pivoted away from the respective one of the engaging members 732 (see FIG. 7) to be disengaged from the respective one of the engaging members 732.

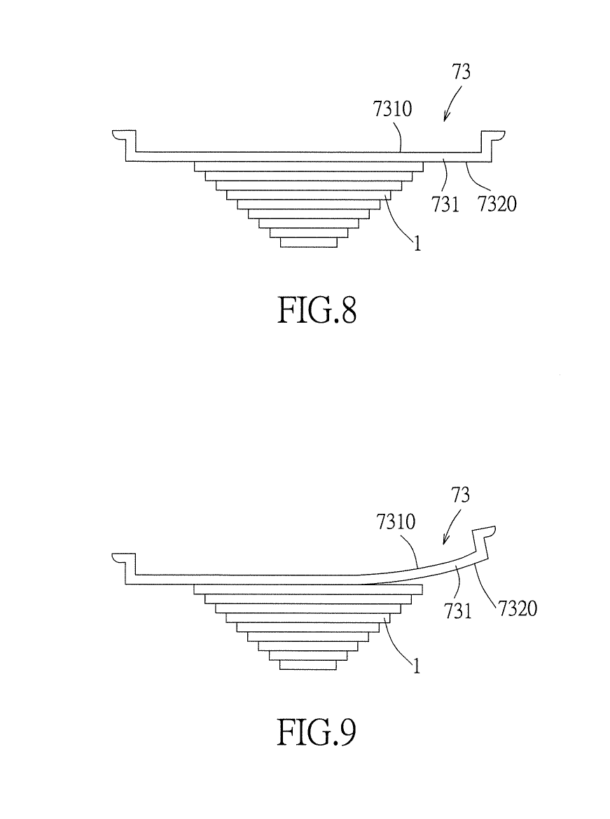

Referring to FIGS. 8 and 9, the flexible forming platform 73 is bendable such that the forming surface 7320 is able to flex away and separate easily from a surface of the product 1.

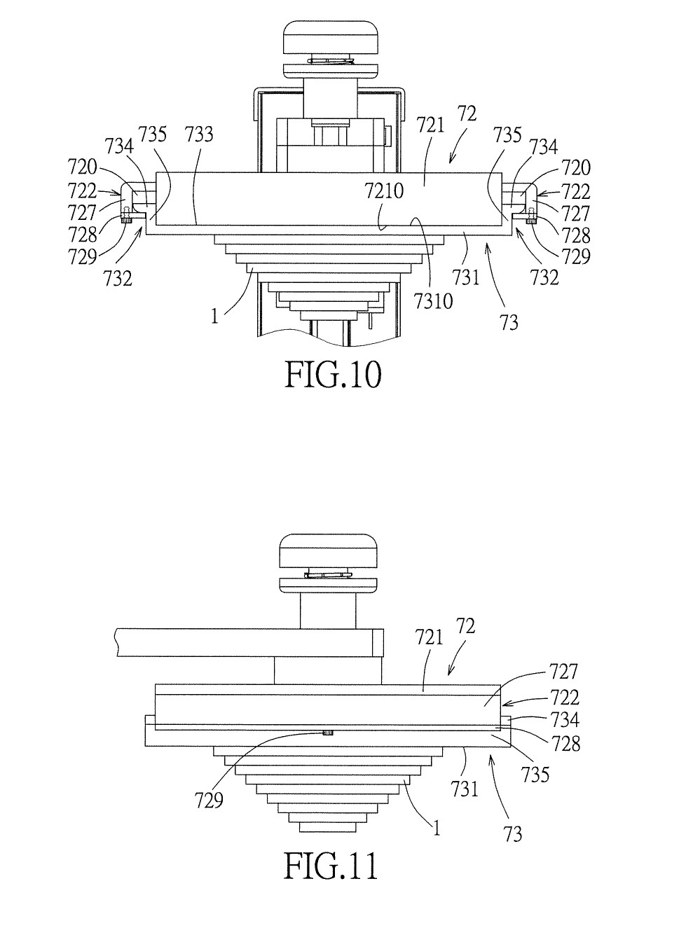

Referring to FIGS. 10 and 11, a second embodiment of the three-dimensional printing machine according to the present invention has a structure similar to that of the first embodiment. The differences reside in the configuration of the holding units 722. Referring particularly to FIG. 10, in the second embodiment, each of the holding units 722 includes an extension wall 727 that extends from the abutting base 721, a carrier part 728 that is substantially parallel to the abutting surface 7210 of the abutting base 721, and a fastening member 729 that connects the carrier part 728 to an end of the extension wall 727 opposite to the abutting base 721. The carrier part 728 extends from the extension wall 727 in a direction toward the abutting base 721. The extension wall 727 and the carrier part 728 collaboratively define a sliding channel 720 to be engaged with the respective one of the engaging members 732. The fastening member 729 is operable to loosen the carrier part 728 from the extension wall 727 and to adjust a size of the sliding channel 720 for facilitating insertion of the respective one of the engaging members 732 into the sliding channel 720.

The fastening member 729 of each of the holding units 722 may be an adjustment screw or a thumbscrew.

Operation steps of the second embodiment are similar to those of the first embodiment. The differences reside in the way of coupling the flexible forming platform 73 to the holding mechanism 72. The fastening member 729 of each of the holding units 722 is unfastened such that the carrier part 728 descends relative to the extension wall 727. Therefore, the sliding channels 720 become bigger in size such that the engaging end 734 of each of the engaging members 732 can be easily inserted into the sliding channel 720 of the respective one of the holding units 722. The fastening member 729 is then fastened such that the abutting base 721 is received in the recess 733 and the positioning surface 7310 of the forming member 731 tightly abuts against the abutting surface 7210 of the abutting base 721. The carrier part 728 of each of the holding units 722 consequently supports the engaging end 734 of the respective one of the engaging members 732 thereon.

To sum up, since the flexible forming platform 73 is flexible in nature, it can be bent to flex the forming surface 7320 away from the surface of a product 1. Without using a tool, such as a putty knife or a shovel that may damage the product 1 or the flexible forming platform 73, the product 1 could be easily removed from the forming surface 7320 of the flexible forming platform 73.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A forming device adapted for use in a three-dimensional printing machine, said forming device comprising:
a holding mechanism including an abutting base that has an abutting surface, and a pair of holding units that are connected to said abutting base and that are respectively disposed at opposite sides of said abutting surface; and
a flexible forming platform including
a forming member that has a forming surface, and a positioning surface opposite to said forming surface, and
a pair of engaging members that are connected to said forming member and that are respectively disposed at two opposite sides of said positioning surface, each of said engaging members being engageable with a respective one of said holding units of said holding mechanism to place said positioning surface of said forming member in tight abutment with said abutting surface of said abutting base.

2. The forming device as claimed in claim 1, wherein said engaging members cooperate with said forming member to define a recess contiguous to said positioning surface, said abutting base being received in said recess such that said positioning surface of said forming member tightly abuts against said abutting surface of said abutting base when said engaging members are respectively engaged with said holding units.

3. The forming device as claimed in claim 2, wherein each of said engaging members of said flexible forming platform includes an engaging end that is substantially parallel to said positioning surface of said forming member, and a connecting wall that extends transversely between and interconnects said engaging end and said forming member, said engaging end protruding from said connecting wall in a direction away from said forming member.

4. The forming device as claimed in claim 3, wherein each of said holding units includes a pivot member that is disposed at the respective one of said opposite sides of said abutting surface, and a hook member that is pivotally connected to said pivot member.

5. The forming device as claimed in claim 4, wherein:
said hook member of each of said holding units includes a hooking part and a pivoting part that extends transversely from said hooking part and that is pivotally connected to said pivot member; and
said engaging end of each of said engaging members of said flexible forming platform is removably engaged with said hooking part of said hook member of the respective one of said holding units.

6. The forming device as claimed in claim 3, wherein:
each of said holding units includes an extension wall that extends from said abutting base, a carrier part that is substantially parallel to said abutting surface of said abutting base, and a fastening member that connects said carrier part to an end of said extension wall opposite to said abutting base, said carrier part extending from said extension wall in a direction toward said abutting base;
said extension wall and said carrier part collaboratively define a sliding channel to be engaged with the respective one of said engaging members; and
said fastening member is operable to loosen said carrier part from said extension wall and to adjust a size of said sliding channel for facilitating insertion of the respective one of said engaging members into said sliding channel.

7. The forming device as claimed in claim 6, wherein said fastening member of each of said holding units is an adjustment screw.

8. The forming device as claimed in claim 1, wherein said flexible forming platform is made of rubber or steel.

9. A three-dimensional printing machine, comprising:
a liquid container having an upper opening;
a laser adapted for producing laser beams;
a scanner adapted for reflecting the laser beams produced by said laser to the liquid container; and
a forming device that includes
a holding mechanism including an abutting base that has an abutting surface, and a pair of holding units that are connected to said abutting base and that are respectively disposed at opposite sides of said abutting surface, said holding mechanism being vertically movable relative to said liquid container such that said holding mechanism is operable to pass said upper opening and to enter said retaining space, and
a flexible forming platform including
a forming member that has a forming surface, and a positioning surface opposite to said forming surface, and
a pair of engaging members that are connected to said forming member and that are respectively disposed at two opposite sides of said positioning surface, each of said engaging members being engageable with a respective one of said holding units of said holding mechanism to place said positioning surface of said forming member in tight abutment with said abutting surface of said abutting base, said flexible forming platform being bendable such that said forming surface is able to flex away and separate easily from a surface of a product.

10. The three-dimensional printing machine as claimed in claim 9, wherein said engaging members cooperate with said forming member to define a recess contiguous to said positioning surface, said abutting base being received in said recess such that said positioning surface of said forming member tightly abuts against said abutting surface of said abutting base when said engaging members are respectively engaged with said holding units.

11. The three-dimensional printing machine as claimed in claim 10, wherein each of said engaging members of said flexible forming platform includes an engaging end that is substantially parallel to said positioning surface of said forming member, and a connecting wall that extends transversely between and interconnects said engaging end and said forming member, said engaging end protruding from said connecting wall in a direction away from said forming member.

12. The three-dimensional printing machine as claimed in claim 11, wherein each of said holding units includes a pivot member that is disposed at the respective one of said opposite sides of said abutting surface, and a hook member that is pivotally connected to said pivot member.

13. The three-dimensional printing machine as claimed in claim 12, wherein:
said hook member of each of said holding units includes a hooking part and a pivoting part that extends transversely from said hooking part and that is pivotally connected to said pivot member; and
said engaging end of each of said engaging members of said flexible forming platform is removably engaged with said hooking part of said hook member of the respective one of said holding units.

14. The three-dimensional printing machine as claimed in claim 11, wherein:
each of said holding units includes an extension wall that extends from said abutting base, a carrier part that is substantially parallel to said abutting surface of said abutting base, and a fastening member that connects said carrier part to an end of said extension wall opposite to said abutting base, said carrier part extending from said extension wall in a direction toward abutting base;
said extension wall and said carrier part collaboratively define a sliding channel to be engaged with the respective one of said engaging members; and
said fastening member is operable to loosen said carrier part from said extension wall and to adjust a size of said sliding channel for facilitating insertion of the respective one of said engaging members into said sliding channel.

15. The three-dimensional printing machine as claimed in claim 14, wherein said fastening member of each of said holding units is an adjustment screw.

16. The three-dimensional printing machine as claimed in claim 9, wherein said flexible forming platform is made of rubber or steel.

17. The three-dimensional printing machine as claimed in claim 9, further comprising a housing that defines a containing space for containing said liquid container, said laser, said scanner and said forming device therein.

18. The three-dimensional printing machine as claimed in claim 17, further comprising a base on which said liquid container is mounted, said base being contained in said containing space,
wherein, said forming device further includes a sliding rail that is connected to and extends vertically from a lateral end of said base, said abutting base of said holding mechanism being operable to move vertically along said sliding rail.
